(19) United States
(12) Patent Application Publication
(10) Pub. No.: US 2021/0402692 A1
(43) Pub. Date: Dec. 30, 2021

(54) DOCKING SYSTEMS AND METHODS FOR APPLICATORS AND PRINT HEADS

(71) Applicant: MAKE COMPOSITES, INC., Burlington, MA (US)

(72) Inventors: Konstantinos Fetfatsidis, Tewksbury, MA (US); Scott Foret, Somerville, MA (US); Tony Kayhart, Cambridge, MA (US); Aniz Baz Radwan, N. Chelmsford, MA (US)

(73) Assignee: MAKE COMPOSITES, INC., Burlington, MA (US)

(21) Appl. No.: 17/360,057

(22) Filed: Jun. 28, 2021

Related U.S. Application Data
(60) Provisional application No. 63/044,435, filed on Jun. 26, 2020.

(51) Int. Cl. B29C 64/25; B33Y 30/00; B33Y 50/02; B29C 64/393; B29C 64/205; B29C 64/232; B22F 10/85; B22F 12/00

(52) U.S. Cl. CPC B29C 64/25; B33Y 30/00; B33Y 50/02; B29C 64/393; B22F 12/222; B29C 64/232; B22F 10/85; B22F 12/38; B29C 64/205

(57) ABSTRACT

In part, the disclosure relates to an applicator management system for fabricating 3D parts. The system includes a first applicator; a housing; a mount, wherein the mount is moveable in one or more directions within the housing; a build plate disposed within the housing, wherein position of build plate is adjustable in one or more directions; and an applicator changer coupled to the moveable mount; wherein the applicator changer includes a first interface to operatively engage the first applicator and a second applicator. In part, the disclosure relates to the use of magnetic coupling or docking system.

### CROSS REFERENCE TO RELATED APPLICATIONS

This application claims priority to and the benefit of U.S. Provisional Patent Application No. 63/044,435 entitled “Docking Systems and Methods for Applicators and Print Heads” filed on Jun. 26, 2020, the disclosure of which is herein incorporated by reference in its entirety.

### FIELD

In part, the disclosure relates to the field of additive manufacture, docking systems, assemblies, and related methods.

### BACKGROUND

Designing and building specialized manufacturing systems and facilities is expensive. Further, creating custom tooling for new products is also a costly endeavor. Clearly there are numerous barriers facing the release of new products that can improve the quality of our lives. This issue applies to final product designs, but also serves as an impediment to prototyping and manufacturing new products.

The advancement of medicine, sports, aviation, safety equipment, and other industries and technologies can all benefit from rapid prototyping and manufacture of new products. To that end, various technologies are undergoing further development to facilitate rapid prototyping and manufacturing parts having enhanced strength and weight characteristics. Advances in computer added design, three-dimensional printing, such as Fused Filament Fabrication (FFF), and others are creating new design options and making new technologies available to engineers.

Unfortunately, some of these technologies are difficult to combine or otherwise use in an integrated fashion. In particular, using and switching between different applicators or tool heads can result in various challenges. The present disclosure addresses the foregoing needs and others.

### SUMMARY

In part, the disclosure relates to an applicator management system for fabricating 3D parts. The system includes a first applicator; a housing; a mount, wherein the mount is moveable in one or more directions within the housing; a build plate disposed within the housing, wherein position of build plate is adjustable in one or more directions; and an applicator changer coupled to the moveable mount; wherein the applicator changer includes a first interface to operatively engage the first applicator and a second applicator. In part, the disclosure relates to the use of a magnetic coupling or docking system in lieu of a canted spring as disclosed herein. The first interface may include any interface device or component or assembly disclosed herein. In one embodiment, the first interface is dock or dock assembly or a coupler. In one embodiment, the first interface is a tool grabber.

In one embodiment, the first interface comprises a coupler comprising a canted spring defining a first bore. In one embodiment, the coupler comprises housing defining a groove and a second bore, the canted spring disposed in the groove. In one embodiment, the first bore and the second bore are substantially coaxial.

In one embodiment, the coupler is a female coupler. In one embodiment the first applicator comprises a coupler comprising a canted spring defining a first bore. In one embodiment the first interface comprises an elongate member sized to be received by a female coupler comprising a canted spring. In one embodiment, the system further includes a holding bracket mounted to the housing, wherein the holding bracket includes a plurality of receivers for storing each applicator.

In one embodiment, the first applicator is a fiber-reinforced polymer prepreg tape. In one embodiment, the system further includes the second applicator. In one embodiment, the second applicator is a Fused Filament Fabrication (FFF)-based applicator. In one embodiment, the second applicator is a metal-based printing applicator.

In one embodiment, the first interface is selected from the group consisting of a magnetic coupler, a ball lock, a tongue and groove system, an interference fit coupler, and an electric coupler. In one embodiment, the second applicator is selected from the group consisting of an inspection applicator, a metrology applicator, a cutting applicator, a combination applicator that includes functions of two or more applicators, and a drill applicator. In one embodiment, a build plate translates along the z-axis defined by the inner perimeter of the housing. In one embodiment, the first interface comprises a stud and a canted spring. In one embodiment, wherein the first interface is selected from the group consisting of a magnetic coupler comprising a slider assembly comprising one or more magnetics and a fixed assembly comprising one or more magnetics, wherein the slider assembly is magnetically repelled from the fixed assembly.

In some embodiments, the first interface includes a magnetic dock assembly. The magnetic dock assembly may be part of a coupler or dock or other tool interfacing system. In one embodiment, the magnetic dock assembly may include a slider assembly defining a first hole and a second hole, the slider assembly comprising a first magnet and a second magnet. In various embodiments, the system or dock assembly may further include a docking pin assembly that may include a first pin and a second pin, and a third magnet and fourth magnet, wherein poles of first magnet and third magnet are oriented to repel each other, wherein the first pin is positioned to enter the first hole and wherein the second pin is positioned to enter the second hole.

In one embodiment, the slider assembly is slidably disposed relative to the first pin and the second pin. In one embodiment, the magnetic dock assembly may include a fixed assembly that may include a pair of elongate pins, a first pair of magnets, and an upper portion and a lower portion; and a slider assembly may include a second pair of magnets and a first stop and a second stop, wherein the slider assembly defines a pair of holes, wherein the pair of holes are sized to receive the pair of elongated pins, wherein the first stop grips the upper portion, wherein the second stop grips the lower portion. In one embodiment, the system further includes a tool grabber and a control system. In one embodiment, the system further includes a contact sensor in electrical communication with the control system and positioned to selectively contact the magnetic dock assembly when the magnetic dock assembly is in one or more sensor contacting positions.

In some embodiments, the system may further include a contact sensor and a printer, the printer may include a control system, wherein the control system directs printing using one or more tools and applicators and grabbing and docking the one or more tools in the magnetic dock assembly.

In one embodiment, the contact sensor generates a signal or stops transmitting a signal to the control system indicative of whether a tool is docked in the magnetic dock assembly. In one embodiment, the control system is programmed to perform a reset or homing operation in response to receiving a signal indicative of a change in tool docking status. In one embodiment, the first applicator is a fiber-reinforced polymer prepreg tape based applicator.

In one embodiment, the first interface may include a coupler comprising a canted spring defining a first bore. In one embodiment, the coupler may include a housing defining a groove and a second bore, the canted spring disposed in the groove. In one embodiment, the first bore and the second bore are substantially coaxial. In one embodiment, the coupler is a female coupler. In one embodiment, the first applicator may include a coupler comprising a canted spring defining a first bore. In one embodiment, the first interface may include an elongate member sized to be received by a female coupler comprising a canted spring.

Although, the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation.

### BRIEF DESCRIPTION OF DRAWINGS

The figures are not necessarily to scale, emphasis instead generally being placed upon illustrative principles. The figures are to be considered illustrative in all aspects and are not intended to limit the disclosure, the scope of which is defined only by the claims.

FIG. 1 is a simplified illustration of a tool carriage used with a tool head docking interface, in accordance with an embodiment of the present disclosure.

FIG. 2 is a simplified illustration of an alternate perspective of the tool carriage shown in FIG. 1 in accordance with an embodiment of the present disclosure.

FIG. 3 is a simplified illustration of a cutaway view of the tool carriage in accordance with an embodiment of the present disclosure.

FIG. 4 is a photograph of the perspective view of a three-dimensional fabrication apparatus using a tool carriage in accordance with an embodiment of the present disclosure.

FIG. 5 is a photograph of a canted coil spring, in accordance with an embodiment of the present disclosure.

FIG. 6A is a simplified illustration of an alternate retention mechanism, in accordance with an embodiment of the present disclosure.

FIG. 6B is a photograph of a perspective view of a housing having a groove for retaining the canted coil spring, in accordance with an embodiment of the present disclosure.

FIG. 7 is a photograph of a tool stud, in accordance with an embodiment of the present disclosure.

FIG. 8 is a diagram of a tool stud and housing coupled together, in accordance with an embodiment of the present disclosure.

FIG. 9 is a photograph of tools coupled to the cradle using tool holder pins, in accordance with an embodiment of the present disclosure.

FIG. 10A is a front perspective view of a tool head shown in an undocked state relative to a spring dock in accordance with an embodiment of the present disclosure.

FIG. 10B is a back perspective view of a tool head shown in an undocked state relative to a spring dock in accordance with an embodiment of the present disclosure.

FIG. 11 is a photograph of the stud that includes a first locking radial groove, in accordance with an embodiment of the present disclosure.

FIG. 12 is a photograph of the stud that includes a second locking radial groove, in accordance with an embodiment of the present disclosure.

FIG. 13 is a diagram describing the forces required to move or remove the stud from the housing for both positions A and B, in accordance with an embodiment of the present disclosure.

FIG. 14 is a photograph of the tool/tool head which starts locked into position A of the tool cradle, in accordance with an embodiment of the present disclosure.

FIG. 15 is a photograph of a tool carriage to tool head docking, in accordance with an embodiment of the present disclosure.

FIG. 16 is a photograph of the tool carriage that is currently locked into the tool and applies further force along an axis parallel to the stud of the tool carriage to move the stud of the tool into position B in its interface with the tool cradle, in accordance with an embodiment of the present disclosure.

FIG. 17 is a photograph of the tool head in position B, unlocked, and showing it can be removed from the tool cradle, in accordance with an embodiment of the present disclosure.

FIG. 18 is a photograph showing re-docked tool, aligned tool studs with the tool cradle, and with the tool advanced until it is locked into position A, in accordance with an embodiment of the present disclosure.

FIG. 19 is a photograph showing disengagement of the tool carriage from tool head and retract ion of the tool carriage to remove the tool carrier's stud from the tool's housing, in accordance with an embodiment of the present disclosure.

FIG. 20 is a perspective view of a magnetic dock slider assembly and a docking pin and magnet assembly shown in an undocked state in accordance with an embodiment of the present disclosure.

FIGS. 21A and 21B are two alternate perspective views of the magnetic dock slider assembly and a docking pin and magnet assembly of FIG. 20 shown in a docked state in accordance with an embodiment of the present disclosure.

FIG. 22A is a simplified illustration of a magnetic dock slider assembly that slides along the main docking pins and is the primary part used to hold the tool in a stable axial position along the pins when docked showing net magnetic force on slider assembly, in accordance with an embodiment of the present disclosure.

FIG. 22B is a simplified illustration of a spring dock assembled by snapping the slider assembly over the backside of the docking pin and magnet assembly showing dock home position, in accordance with an embodiment of the present disclosure.

FIG. 23 is a perspective view of a magnetic dock slider assembly, a tool head, and a docking pin and magnetic assembly showing opposing and repelling the magnets of each of the foregoing in accordance with an embodiment of the present disclosure.

FIG. 24 is a perspective view of a magnetic dock slider assembly, a tool head, and a docking pin and magnetic assembly showing a dock home position in accordance with an embodiment of the present disclosure.

FIG. 25 is a perspective view of a magnetic dock slider assembly, a tool head, and a docking pin and magnetic assembly showing opposing and repelling the magnets of each of the foregoing in accordance with an embodiment of the present disclosure.

FIG. 26 is a side view of magnetic dock slider assembly and a docking pin and magnetic assembly during tool pickup using a tool grabber in accordance with an embodiment of the present disclosure.

FIG. 27 is a simplified illustration of the tool grabber mated with the tool and in the process of releasing the tool from the dock in accordance with an embodiment of the present disclosure.

FIG. 28 is a simplified illustration of a tool drop off process with the tool being positioned relative to and released to be stored in the dock, in accordance with an embodiment of the present disclosure.

FIG. 29 is a simplified illustration of the tool grabber disengaging the lock mechanism and releasing the tool head at the dock slidably positioned on the pins, in accordance with an embodiment of the present disclosure.

FIG. 30 is a schematic drawing showing sliding component and fixed components of a dock in which stops or tabs of sliding component are pushed away from the fixed component and held by the stops or tabs indicative of no tool being present, in accordance with an embodiment of the present disclosure.

FIG. 31 is a schematic drawing showing a sliding component and a fixed component of a dock in which one or more stops of the sliding component are pushed towards the fixed component and contacting the fixed component indicative of a tool being present, in accordance with an embodiment of the present disclosure.

### DETAILED DESCRIPTION

Described herein are apparatus and systems for providing a secure disconnectable/selectably coupled or releasably coupled interface between two mounting surfaces. In various embodiments, each of the mounting surfaces are on, or a portion of, an apparatus intended to be securely connected to a second apparatus.

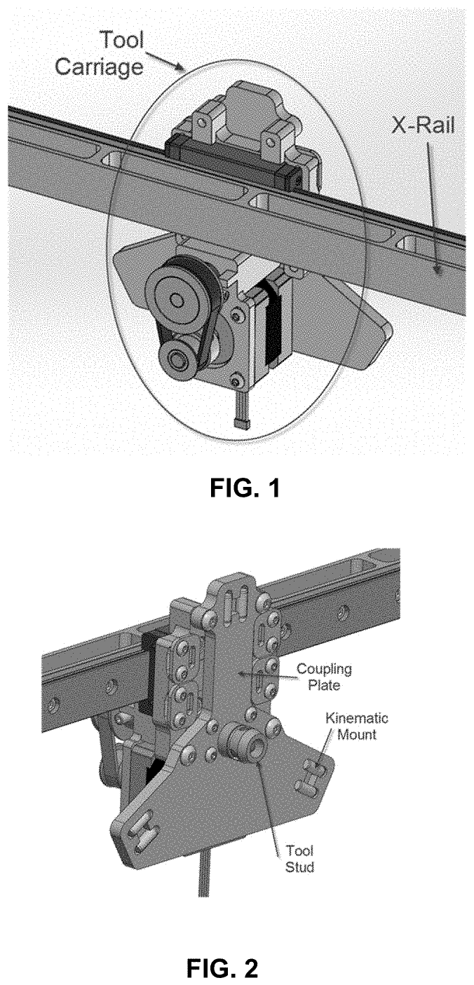

FIG. 1 is a simplified illustration of a tool carriage used with a tool head docking interface. As shown, the tool carriage is mounted on the X-rail bar. The tool carriage is a mechanical assembly which rides along horizontal linear rail mounted on the X-rail bar. The tool carriage securely holds each individual tool head during operation. In various embodiments, a tool head includes a print head, a tape head, and/or other tool heads used in the fabrication of three-dimensional objects.

FIG. 2 is an alternate perspective of the tool carriage shown in FIG. 1. As shown, the tool carriage includes a coupling plate, kinematic mount, and a tool stud. The coupling plate employs the tool stud, locking mechanism, and kinematic mounting points to securely dock and retain interchangeable tool heads.

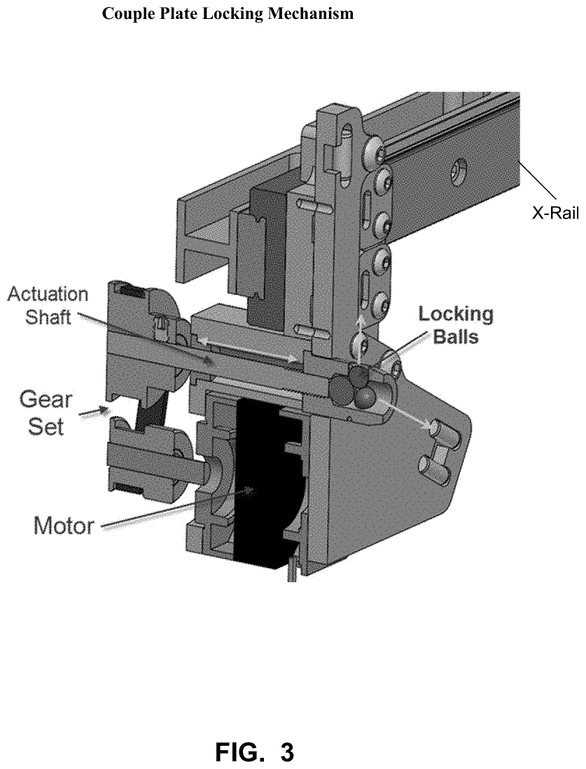

FIG. 3 is a cutaway view of the tool carriage shown in FIG. 1. As shown, a stepper motor mounted on the tool carriage to facilitate connecting the tool carriage to a tool head. In this embodiment, the stepper motor is configured to rotate the actuation shaft, which is threaded, to translate horizontally. Upon being activated, the actuation shaft acts upon the locking balls and forces the locking balls radially outward from within the locking stud. The locking balls interact with the corresponding coupling plate on a tool head, which results in a clamping force between a tool head and the tool carriage. The clamping force locks the tool carriage to the desired tool head.

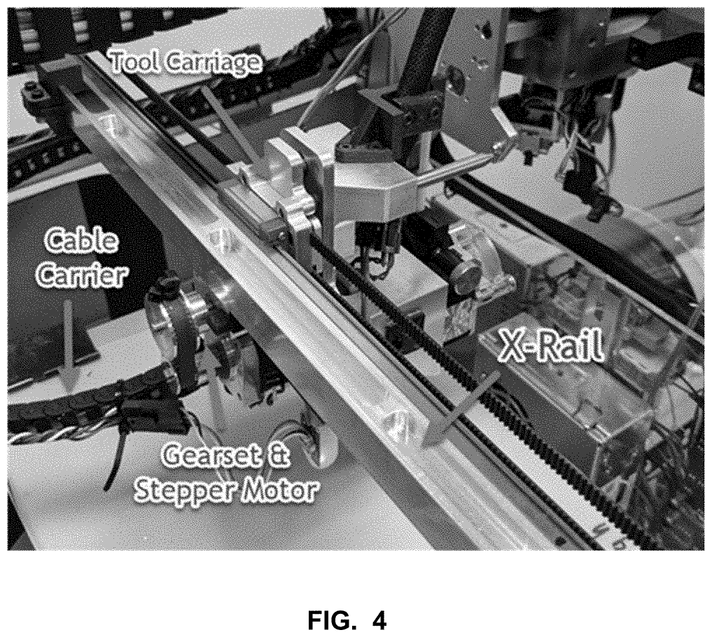

FIG. 4 is a perspective view of a three-dimensional fabrication apparatus using a tool carriage as described in FIGS. 1-3. As shown, the tool carriage is coupled to a tool head using the locking balls within the locking stud.

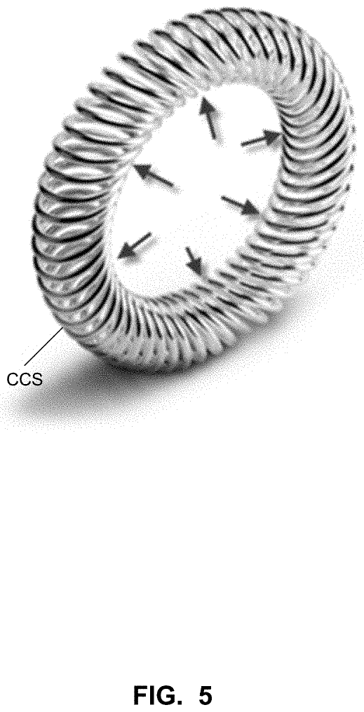

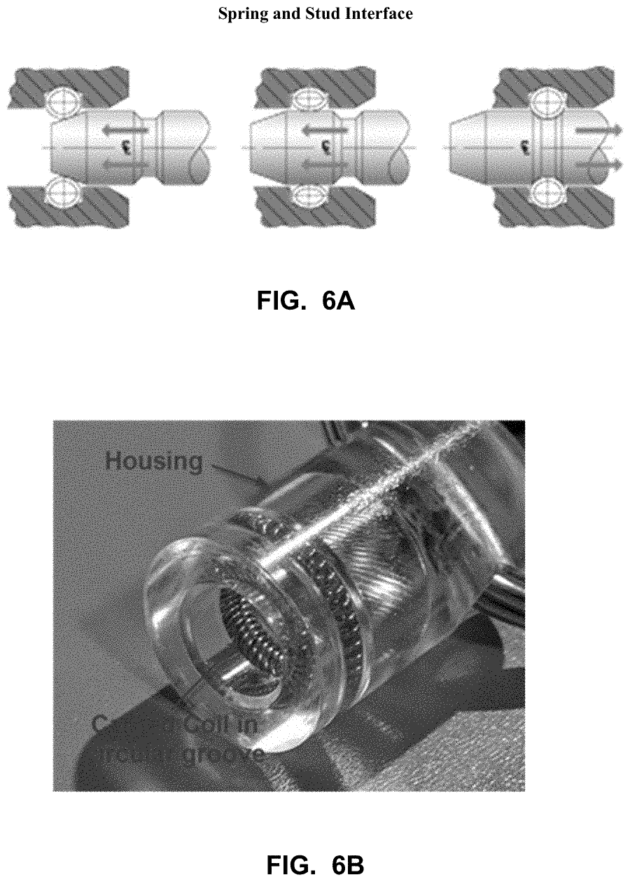

FIG. 5 is a simplified illustration of a canted coil spring. FIG. 6A is a simplified illustration of an alternate embodiment of a stud interface between a tool carriage and a tool head. As shown, a canted coil spring and a stud are used in place of the apparatus described above. Instead of using a step motor, threaded shaft, and locking balls, FIG. 6A shows an alternate retention mechanism. The canted coil spring CCS is mounted within an internal groove of a tool head coupling plate. The canted coil spring is designed and configured to compress the inner diameter radially outward. A modified stud is constructed and configured to mate with the tool head coupling plate which is comprised of a shaft with a groove for receiving the compressed canted coil spring.

FIG. 6B is a perspective view of a housing having a groove for retaining the canted coil spring. In this embodiment, the housing is configured and constructed to receive a tool stud, which is secured into place using the canted coil spring. Upon applying pressure to the canted coil spring using a tool stud, the canted coil spring compresses until a groove in the tool stud aligns with the groove in the housing, thereby allowing the canted coil spring to be disposed within the groove of the tool stud and the housing. When residing within the grooves of the tool stud and the housing, the canted coil spring holds the tool stud and the housing together with a force defined by the construction of the canted coil spring.

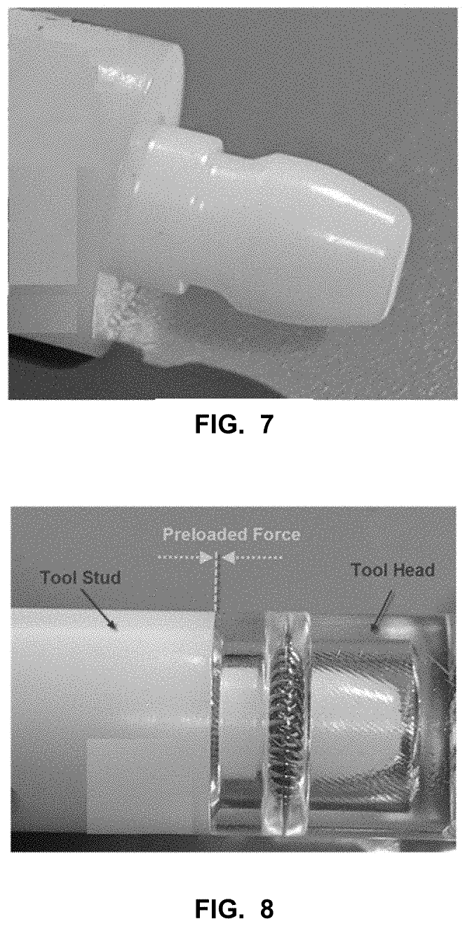

FIG. 7 is a simplified view of a tool stud for use with the housing shown in FIG. 6B. In contrast to the stud assembly shown in FIG. 2, use of the tool stud does not need the shaft and step motor shown in FIG. 2.

A tool carriage is docked to a tool head using the tool docking system, shown in FIGS. 5, 6A, 6B, and 7. A tool carriage is docked when the tool stud is inserted into the stud pocket of the tool heads coupler plate. The stud is advanced far enough such that the spring, located within the Inner diameter hole of the stud pocket, can expand into its radial groove.

FIG. 8 shows a diagram of a tool stud and housing coupled together. As shown, the spring expands to fill the void between the parts (groove to groove) and results in axially loading the joint face together. This resulting clamping force is used to preload the coupling plate's kinematic mount. Undocking is achieved by overcoming a fixed maximum clamping force. Maximum force is dependent on tool stud and tool head groove dimensions as well as the size and configuration of the canted coil spring.

Tool Head to Tool Cradle Docking

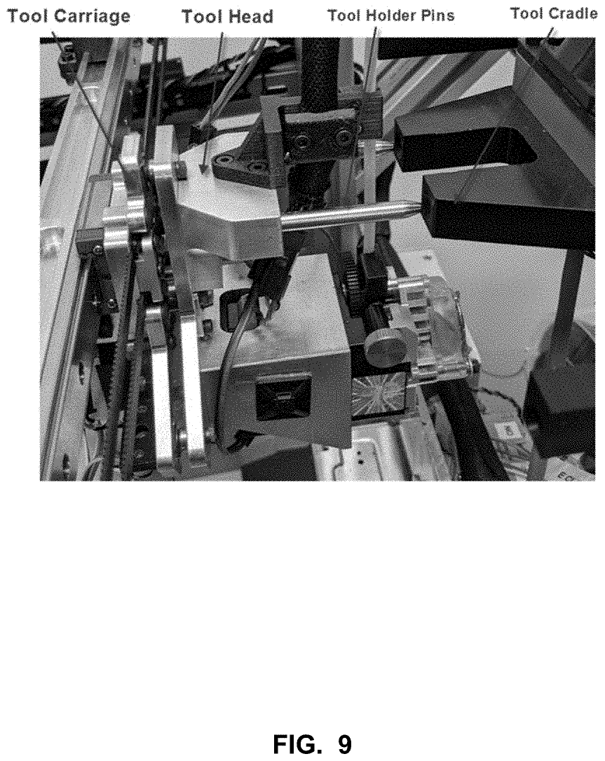

Generally Individual tool heads are stored in the tool cradle when not attached to the tool carriage. Typically, tools are coupled to the cradle using tool holder pins, as shown in FIG. 9. Generally, these pins are inserted into the tool Stand and are used to support the tool head once the carriage has been disengaged from the tool. Using tool holder pins can be problematic, however, as tool heads can be knocked off the tool cradle thereby potentially causing damage to the tool head. Finding improvements to three-dimensional fabrication would be beneficial to industry.

In various embodiments, a fabrication system uses a secure disconnectable interface to connect a tool head to a tool cradle dock. The secure disconnectable interface is comprised of a stud and a housing, which can be implemented in a configuration where the tool stud is mounted to the tool head or where the tool stud is mounted to the housing.

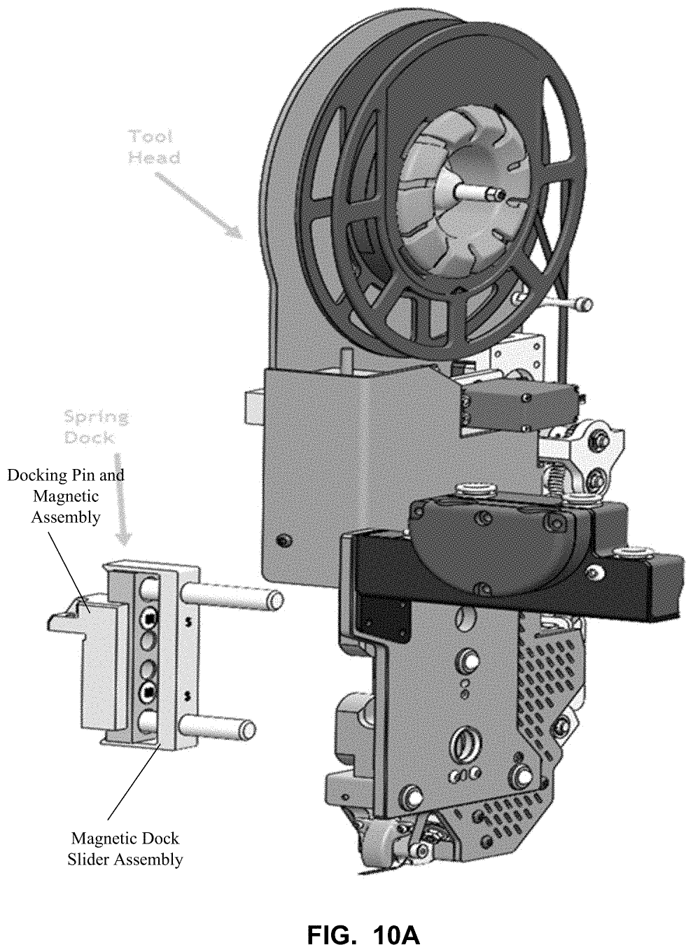

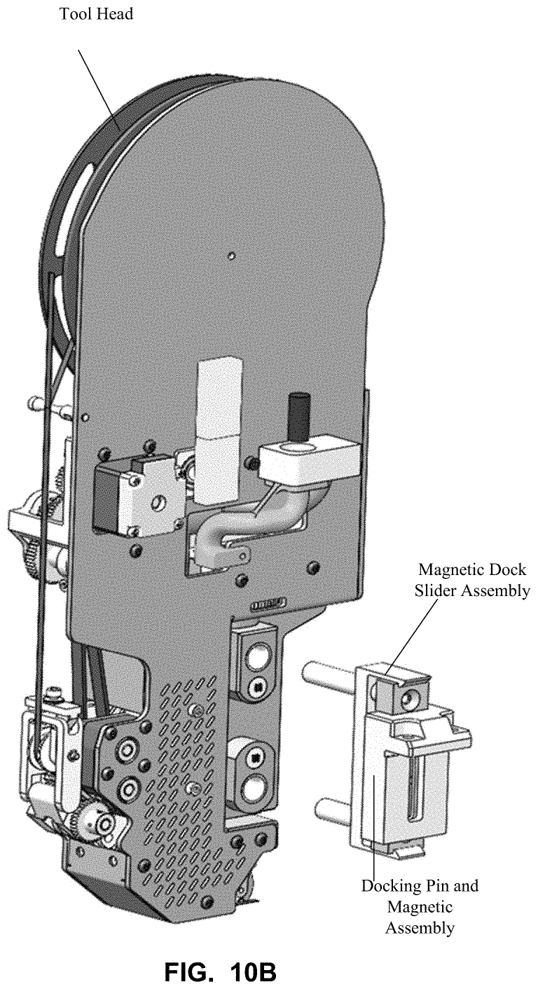

FIG. 10A is a front perspective view of a tool head shown in an undocked state relative to a spring dock. FIG. 10B is a back perspective view of a tool head shown in an undocked state relative to a spring dock. Additional details relating to the spring dock and the use of magnetic repulsion to establish a springiness or braking forces between a slider assembly are discussed in more detail below.

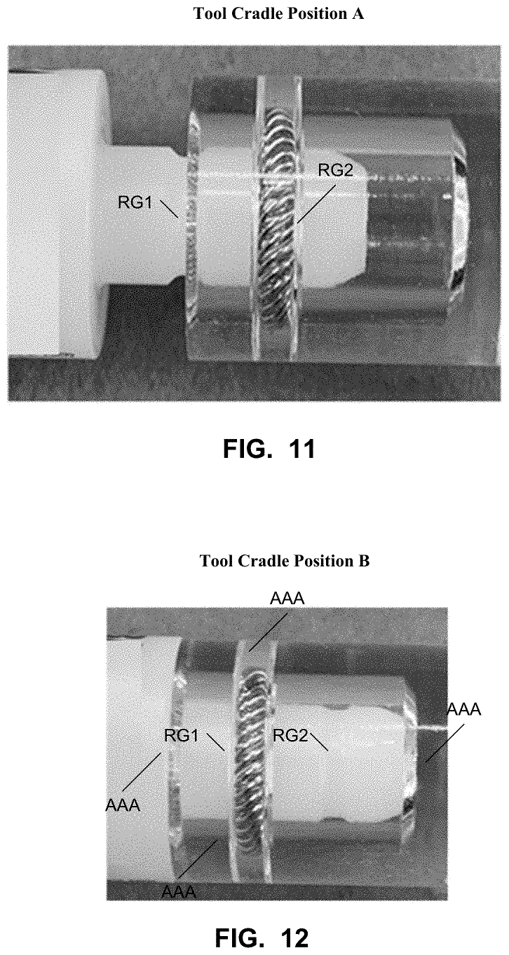

In various embodiments, the stud includes a first locking radial groove and a second locking radial groove for interacting with the housing containing the canted coil spring. When the stud is placed in the housing such that the canted coil spring expands into the first locking radial groove, the first locking radial groove is configured to compress the canted coil spring such that the stud can only freely move in one direction. As shown in FIG. 11, the stud includes a first locking radial groove RG1 and a second locking radial groove RG2, as described above. Once the stud is placed into the housing such that the canted coil spring expands into the first locking radial groove (position A), the canted coil spring is compressed such that the stud must be pushed further into the housing such that the canted coil spring is compressed in the second locking radial groove RG2 (position B) (See FIG. 12) to be released from the housing.

As shown in FIGS. 11 and 12, the first locking radial groove (position A) physically orients the canted coil spring in such a manner that it is not allowed to compress normally and thus prevents the stud from being removed from the housing. To orient the canted coil spring such that it can be removed, the stud must be advanced to the second locking radial groove (position B). Once the stud has fully been advanced to position B, the stud can be withdrawn.

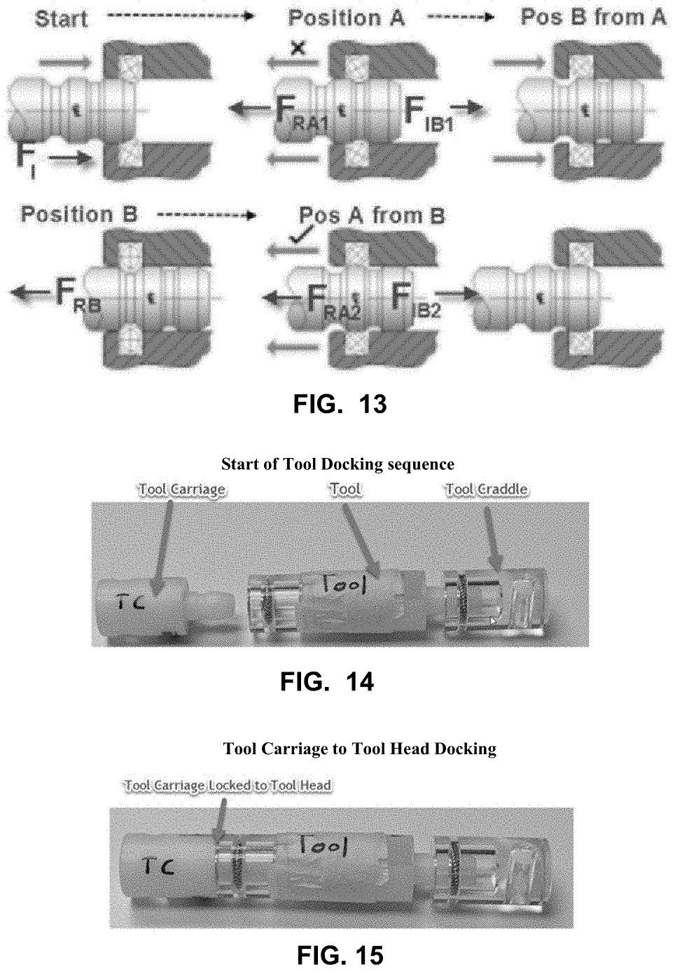

FIG. 13 shows a diagram describing the forces F₁, F_{RA1}, F_{IB1}, F_{RB}, F_{RA2}, and F_{IB2} required to remove the stud from the housing for both positions A and B. Combining embodiments described above, a tool carriage can interact with the tool head and tool cradle without the need for electricity or motorized intervention, which simplifies operation of the fabrication system.

FIGS. 14-19 show diagrams of how the abovementioned locking mechanisms work with a tool carriage, tool head, and a tool cradle, in accordance with an embodiment of the present disclosure. As shown in FIG. 14, the tool head starts locked into position A of the tool cradle.

As shown in FIG. 14, the tool carriage is attempting to utilize the tool and the tool carriage stud is driven into the tool head and inserted into the secure disconnectable locking mechanism. Once inserted, the tool head is securely locked and retained by the tool carriage as shown in FIG. 15. In various embodiments, the canted coil spring in both the tool and the tool cradle can be constructed to activate and/or release upon use of a specified force. For example, in one embodiment, the canted coil spring is configured to activate or release upon use of about 8 pounds of force.

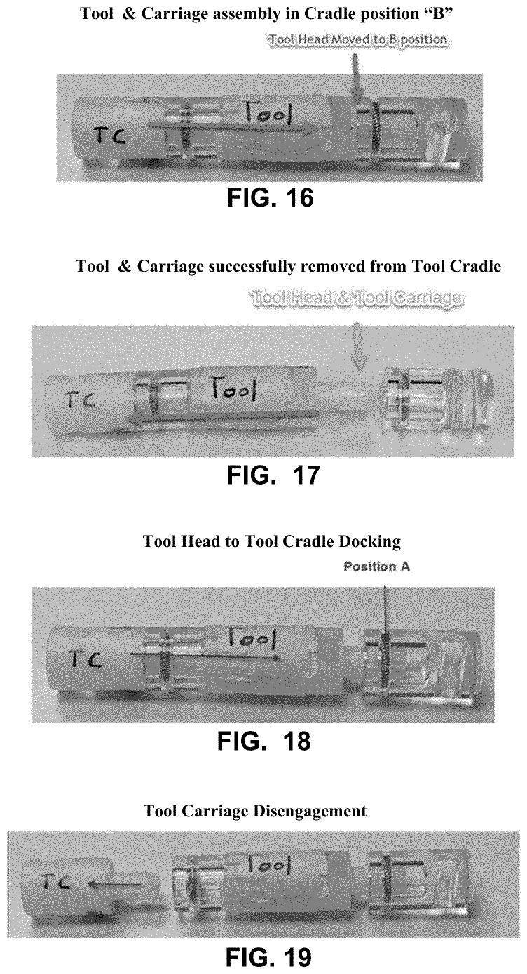

As shown in FIG. 16, the tool carriage is currently locked into the tool and applies further force along an axis parallel to the stud of the tool carriage to move the stud of the tool into position B in its interface with the tool cradle. In this position, the canted coil spring has been reoriented to allow the tool to be removed from the tool cradle.

As shown in FIG. 17, once the tool head is in position “B”, the tool head is now unlocked and can be removed from the tool cradle. Once the tool carriage is reversed, the tool carriage pulls the tool from the tool cradle. In various embodiments, the force needed to overcome the canted coil spring in the tool and the tool cradle can be configured to different values. For example, in one configuration, the force required to remove a tool head from the tool cradle is configured to be about 3 pounds and the force required to remove the tool carriage from the tool is 8 pounds of force. As shown in FIG. 18, to re-dock the tool, align the tool studs with the tool cradle and advance tool until it is locked into position “A”. As shown in FIG. 19, to disengage the tool carriage from tool head, retract the tool carriage to remove the tool carrier's stud from the tool's housing.

Exemplary Spring Dock Embodiments

Each tool mounted within the printer has its own tool dock. A tool dock is used to hold tools while they are not being used by the printer. In part, the disclosure relates to a magnetic spring dock. The spring dock allows for the repeatable pick up and release of printer tool heads/applicators to a known and stable position. In various embodiments, the spring dock uses magnetic force to hold the tool in the docked position, as well as provide a preloading force between the tool and tool coupler during pickup operations.

As introduced above, FIGS. 10A and 10B are front and back perspective views, respectively, of a tool head shown in an undocked state relative to a spring dock. A given tool head or tool may be stored on a spring dock and removed therefrom as part of a pickup process for differencing printing modes. Different tools and applicators may be slidably disposed on pins of a given dock embodiment or by using other attachment, interface or coupling methods.

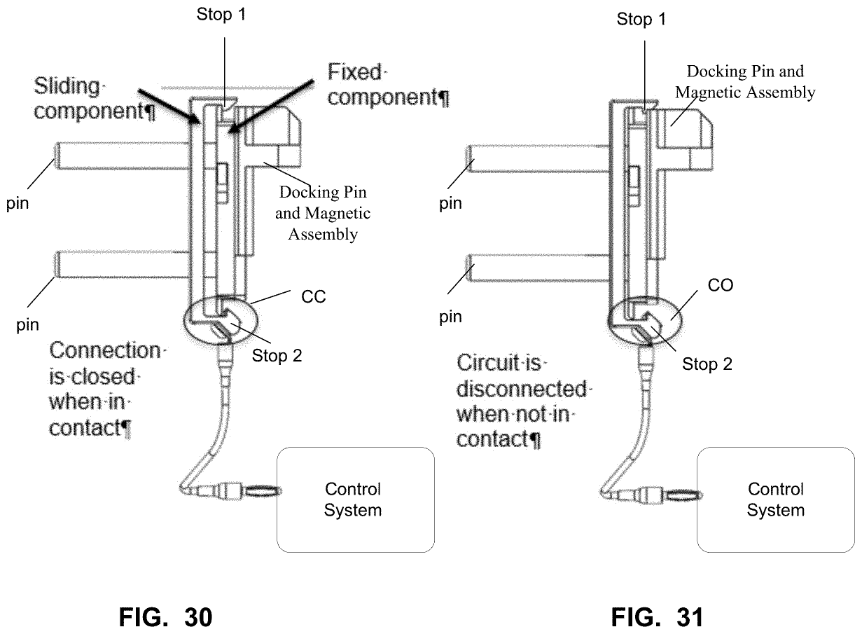

As discussed below with regard to FIGS. 30 and 31, the orientation or absence of a given tool on a given dock may be detected using a sensor correlated with position of one or more slidable components of the dock. In some embodiments, a closed circuit state may be correlated with one or more stops being positioned in a home or rest state indicative of no tool being docked. In some embodiments, an open circuit state may be correlated with one or more stops not being positioned in a home or rest state as a result of a slidable component of the dock contacting a fixed component or otherwise driven past the home or rest state and indicative of a tool being docked. In various embodiments, the open and closed circuits states may be reversed or other sensors, switches, contact sensors, or other assemblies may be used to signal whether or not a tool is in a docked state relative to a particular dock.

Spring Dock Components

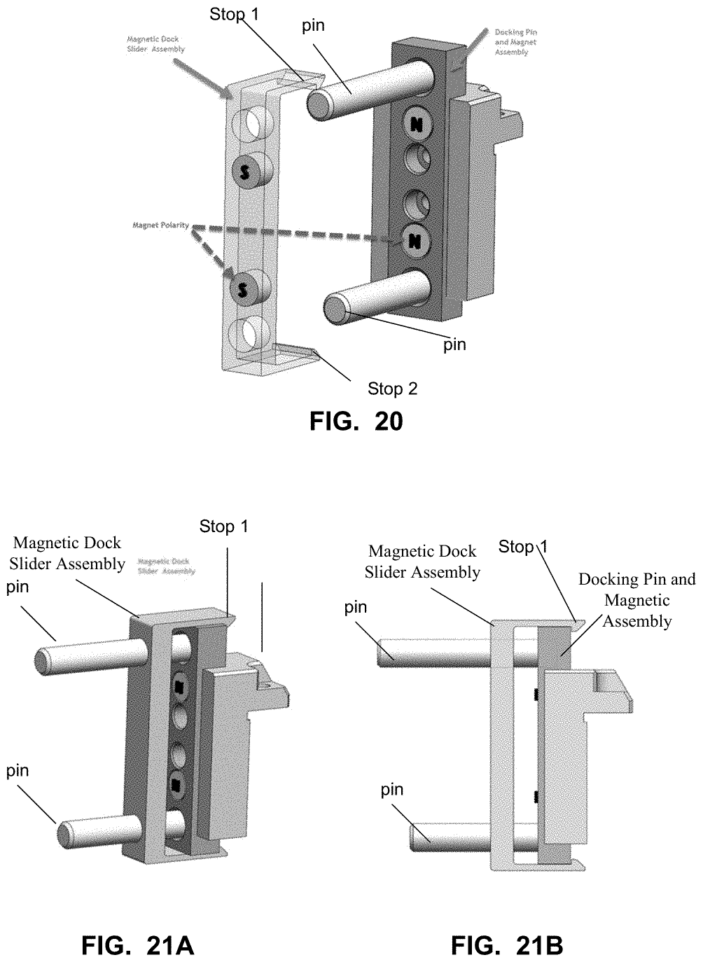

The spring dock may include the various components such as, for example, a magnetic dock slider assembly and a docking pin and magnetic assembly as shown in FIGS. 20, 21A, and 21B. The slider assembly slides along the main docking pins, and is the primary part used to hold the tool in a stable axial position along the pins when docked. The slider also houses two magnets with aligned poles. In various embodiments, the docking pin assembly is fixed to the printer. The weight and orientation of the tool while docked is controlled by the two main docking pins. This assembly also has two magnets with aligned poles.

Spring Dock Assembly Features

Spring dock is assembled by snapping the slider assembly over the backside of the docking pin and magnet assembly as shown in FIGS. 21A and 21B. The stops, stop 1 and stop 2, may extend over a grip or clip to docking pin assembly. In addition, the pairs of magnets in the fixed and slider assembly of the dock are oriented to repel each other.

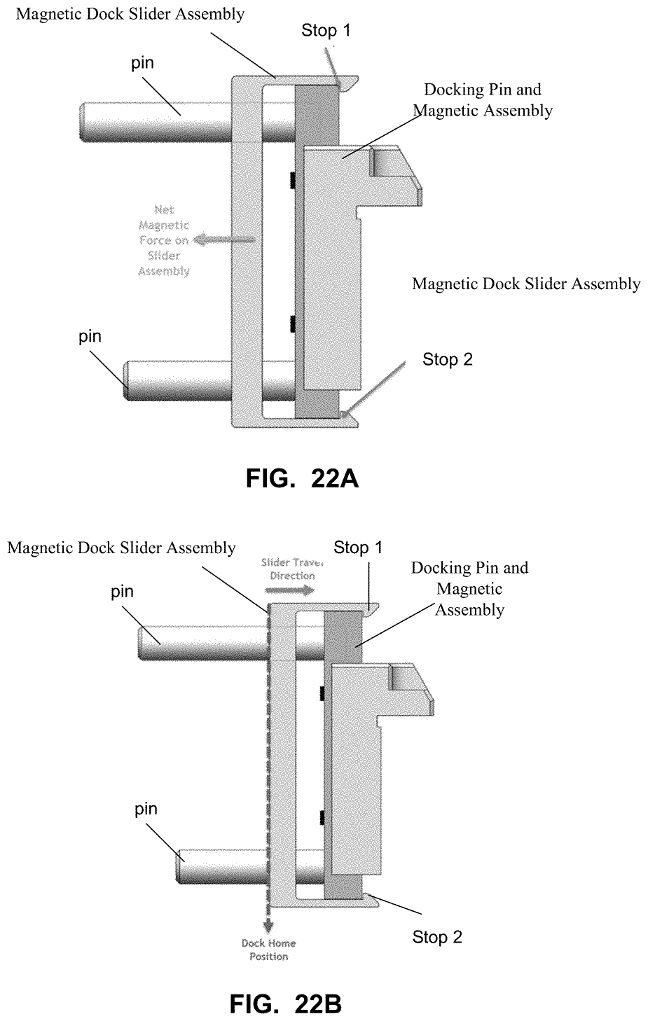

Once installed, the magnets located within the slider assembly oppose and repel the magnets of the docking pin assembly. Various details relating to the net magnetic force on slider assembly, slider travel direction, and dock home position are shown in FIGS. 22A and 22B. This purposeful alignment of similar pairs causes the slider assembly to push itself away from the magnets of the docking pin assembly. The slider is pushed away until engaging two physical stops located at the top and bottom of itself. This position is neutral or the home position of the dock slider assembly. The slider assembly will always return to this position unless acted upon.

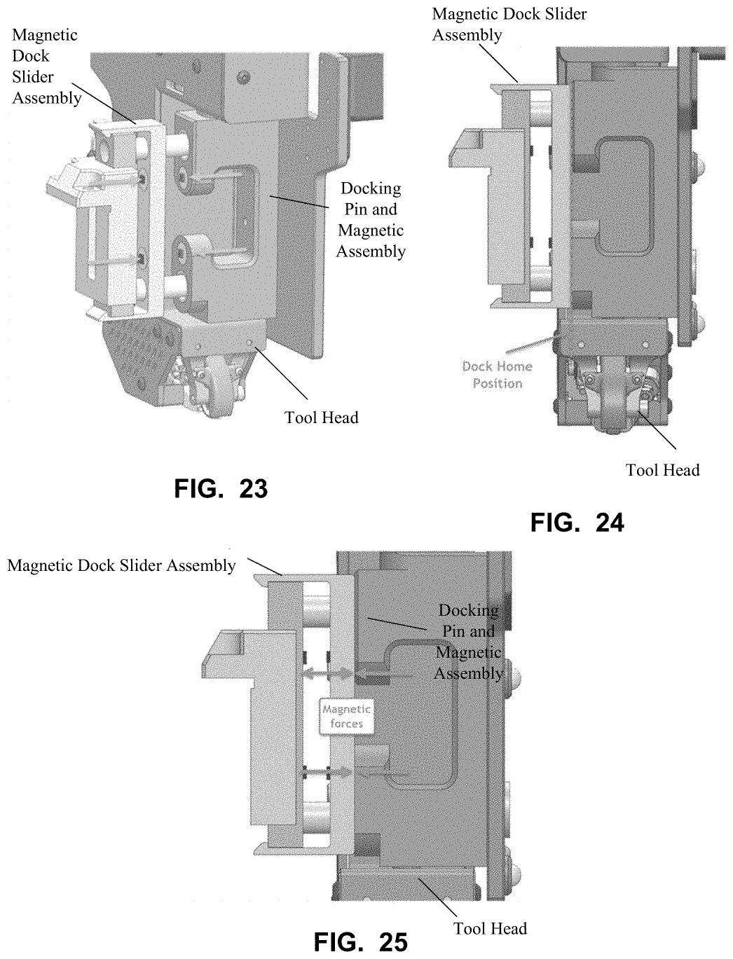

When a tool is installed onto the dock, the magnets located within the tool are attracted to the magnets located in the dock slider assembly. This attraction force holds and positions the tool at the neutral or home position of the dock slider assembly. FIGS. 23 and 24 show different perspective views of a tool installed onto the dock. FIG. 25 shows the repelling magnetic forces between the slider assembly and the fixed pin assembly.

Tool Pick Up

Since the lower docking pin and receiver have a looser tolerance than the upper pin and receiver. It permits a small rotational motion of the tool. This rotational motion can permit the kinematic couplings to mate better when pre-loaded in the spring dock. Thus further reducing the forces required on the grabber to pull the tool into position.

The top pin and receiver are more closely manufactured within suitable tolerances such that the tool cannot sag or droop when stored in its dock. Ensuring that the top kinematic foot is at the correct height to mate with its receiving kinematic coupler.

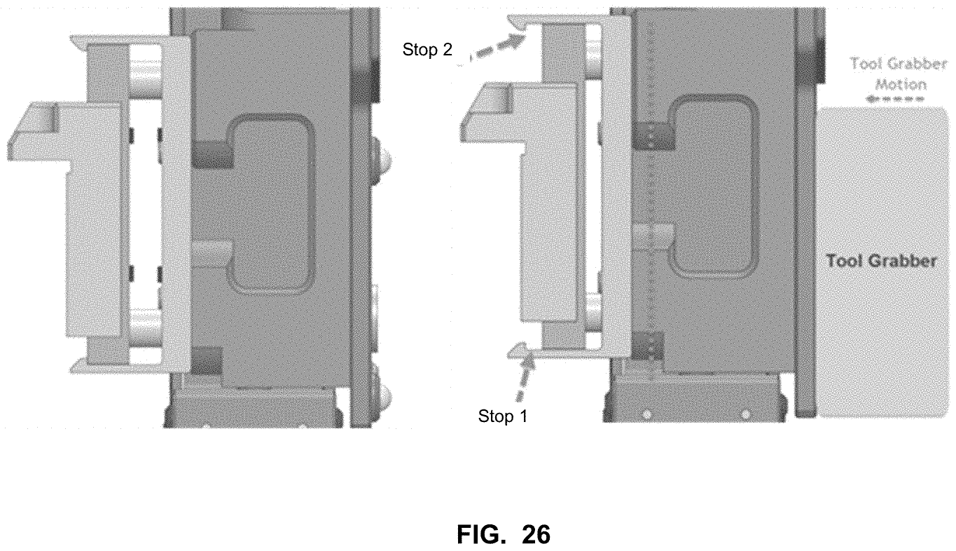

As shown in the embodiment of FIG. 26, during tool pickup, the tool grabber is mated with the tool and the grabber continues to push the slider assembly a few millimeters from the neutral position. On the left, the tool is shown docked, prior to being coupled to tool grabber/tool coupler.

The decrease in distance between the dock slider and docking pin assembly causes the opposing forces of the magnets in the dock to increase. The tool grabber is held in this position while actuating the mechanism used to retain the tool head. While held in this position, the slider assembly imposes a controlled preload force between the tool and tool grabber. This force, which holds the tool in contact with the tool grabber, is used to properly locate and maintain contact of the kinematic joint between the two.

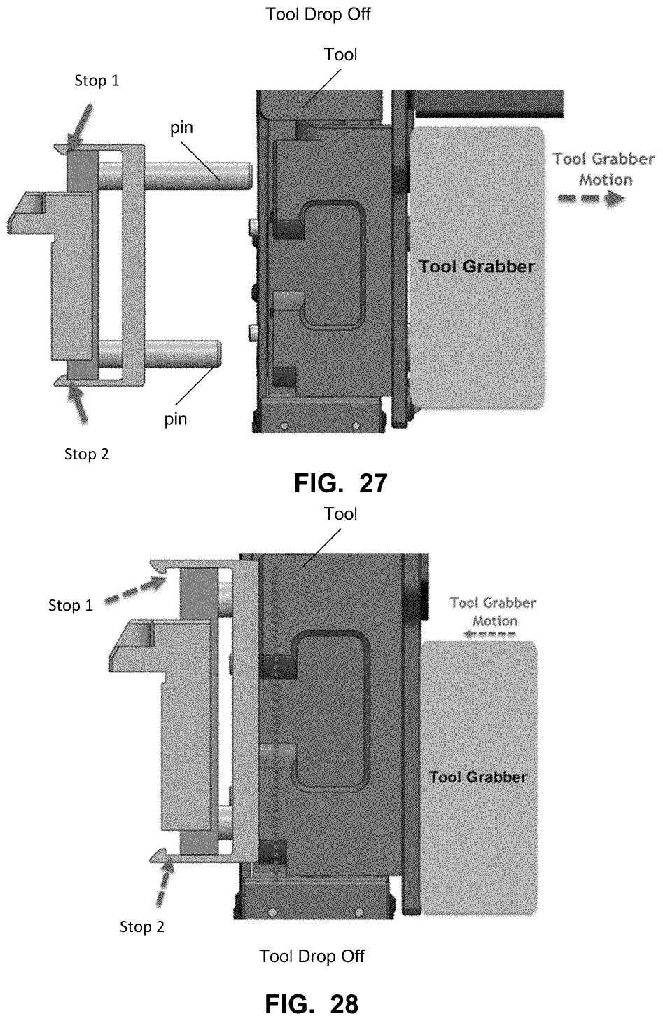

After completing the actuation/locking of the tool and tool grabber, the tool grabber is moved away from the dock assembly as shown in the embodiment of FIG. 27. The translation force of the tool grabber is high enough to break the magnetic force between the tool head and dock slider, releasing the tool from the dock. The dock slider returns to the neutral position with removal of the tool grabber force.

Tool Drop Off

In various embodiments, tool drop-off is a reverse of the pick-up routine. An exemplary embodiment of this is shown relative to FIG. 28. The tool head and tool grabber are driven to a position a few millimeters past the slider neutral position.

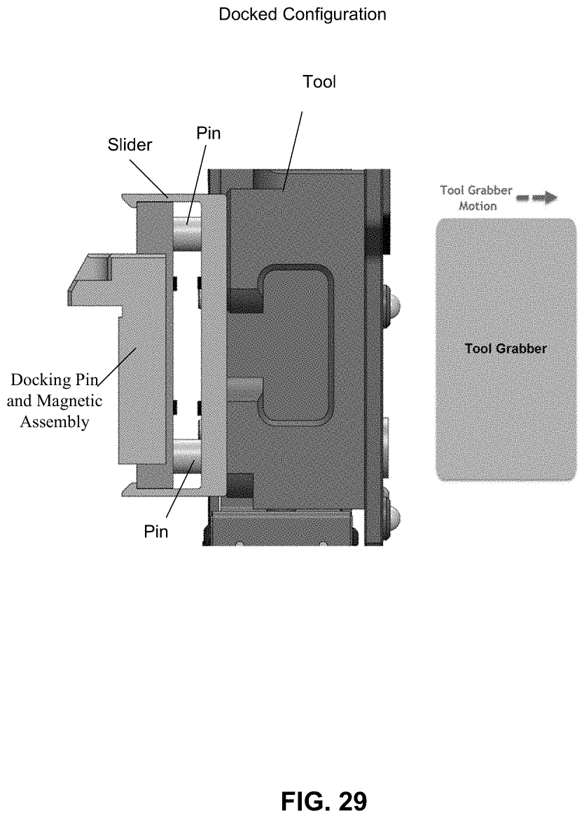

The tool grabber disengages the lock mechanism and releases the tool head. The tool grabber is pulled away from the tool. The dock slider is returned to the neutral position of the dock, and magnetic force between the tool head and slider are reestablished as shown in the docked configuration of FIG. 29.

Control System, Alarms, Homing, and Tool Management Features

In various embodiments, a processor or microprocessor-based control system may be used to monitoring various operating states and positions and displacement of various components of a given docking assembly embodiment. In some embodiments, the control system may sense the displacement of one or more sliding components of a dock assembly. The contact of one or more stops of a component of the dock may work in conjunction with a sensor to send or stop sending control signals indicative of the presence or absence of a tool.

FIG. 30 is a schematic drawing showing sliding component and fixed components of a dock in which stops or tabs of sliding component are pushed away from the fixed component and held by the stops or tabs indicative of no tool being present. As shown, a control system for the printer, which may be implemented using one or more ASICs, a processor, software, and/or firmware can be used to respond to contact or other sensors inputs or the lack thereof to indicate whether a tool is docked. FIG. 31 is a schematic drawing showing sliding component and fixed components of a dock in which stops or tabs of sliding component are pushed towards the fixed component and contacting the fixed component indicative of a tool being present, in accordance with an embodiment of the present disclosure.

When sliding component is moved inward (toward the fixed component) a sensor is switched off as shown in FIG. 31, this open circuit condition/lack of a control signal allows the control system to determine that a tool is present. This follows because the tool has been pushed all the way in to cause the sliding component to push against the fixed component and disconnect the circuit. The circuit disconnect can be designed to occur by placing a contact sensor at one or both stops (stop 1 and stop 2). Other mechanical, electrical, optical, electro-optical, and other switching device or sensors may be used in various embodiments.

If a tool change command is made by the control system and there is not loss of contact as indicated by disconnected contact sensor or other sensor circuit being in an open circuit state, it indicates the tool is not present in the dock. In turn, the control system may direct the tool coupler/grabber to continue to attach itself to the tool and not let it go. In some embodiments, a prompt appears, telling the user that there is a docking error and a reset is needed. In other embodiments, the control system may issue a reset command or institute a homing operation to confirm orientation of tool head status is known. In FIG. 30, a closed circuit CC condition indicates that no tool is in the dock. In FIG. 31, a “circuit open” CO state indicates that a tool is in the dock. These closed and open states may be reversed in various embodiments. Other states, sensors, switches, mechanical triggers, etc., may be used in various embodiments to indicate a tool docked or no tool docked state for the control system to use as an input.

Using docking status information helps prevents tools from being dropped by the coupler after an event such as skipped steps which throws off the global coordinates (X & Y) of the system. Once those coordinates are unreliable, the coupler is being directed based on incorrect information and may operate as if it is in motion to the tool dock position to dock a tool, but in reality it's going elsewhere. If “elsewhere” is not aligning the tool with the docking pins, then once the coupler/tool grabber disengages, the tool will simply drop. This can damage a valuable tool head, the printer itself, and also lead to a catastrophic print failure.

When the sliding component is in its resting position the sensor is switched on in some embodiments or another signal indicating the same is transmitted to control system. The circuit is created through the contact between the sliding component's stop or tabbed component that grip or engage with the upper and lower portions of the fixed component. When the dock is in this rest position, it indicates that no tool has been docked. In various embodiments, the disclose relates to one or more methods of controlling a printer that includes a dock assembly, a control system, and one or more sensors, detectors, or assemblies for performing one or more of the steps outlined herein.

In various embodiments, different tool heads or applicators may be used with the spring dock and other embodiments disclosed herein, including, without limitation, inspection applicator, a metrology applicator, a cutting applicator, a combination applicator that includes functions of two or more applicators, and a drill applicator. In one embodiment, the build plate translates along the z-axis defined by the inner perimeter of the housing. In various embodiments the spring dock, slider assembly, and other docking components disclosed herein may include a ball lock, a tongue and groove system, an interference fit coupler, and an electric coupler. References to tool heads include applicators, and vice versa.

In some embodiments, mechanical coupling, magnetic coupling, tongue and groove, suction-based, pressure fit, pneumatic, and other systems can be used to engage an applicator, release an applicator, and then switch to another applicator. One or more robotic elements, gantries, frames, and other elements can be used to support applicator swapping, docking, releasing, and storage.

In many embodiments, the applicators connected to each of the kinematic couplers can be changed through a mating and docking processes. Both the position and the tool connected to the kinematic coupler may be modified or controlled using instructions provided to a microprocessor or one or more processors or computing devices in wireless or electrical communication with the printer.

In one embodiment, the composite tape includes a group of reinforcing fibers disposed in a carrier material. The ratio of the volume of the reinforcing fibers to the carrier materials is greater than about 0.3 in one embodiment. In one embodiment, volume fraction ratio ranges from about 0.4 to about 0.6. In one embodiment, volume fraction ratio ranges from about 0.5 to about 0.6. In one embodiment, the volume fraction ratio is less than about 0.7. In one embodiment, volume fraction ratio (VFR) ranges from about 0.5 to about 0.7.

In various embodiments, the carrier is a polymeric material. In one embodiment, the carrier includes one or more components selected from the group consisting of a polymer, a cross-linking agent, a resin, a thermoset material, a thermoplastic material, and a catalytic agent.

Any fiber suitable for the desired impregnation into a tape may be used. Examples of suitable fibers impregnated into the tape include, but are not limited to, carbon fibers (e.g., AS4, IM7, EVI10), metal fibers, glass fibers (e.g., E-glass, S-glass), and Aramid fibers (e.g., Kevlar). Multiple different types of fibers may be impregnated into the tape, in accordance with certain embodiments. Suitable pre-impregnated tapes can be purchased from a variety of commercial vendors, including Toray/TenCate, Hexcel, Solvay, Barrday, Teijin, Evonik, Victrex, or Suprem.

In some embodiments, the tape has a certain width. In some embodiments, the width is greater than or equal to about 1 mm, greater than or equal to about 1.5 mm, greater than or equal to 2.0 mm, greater than or equal to about 2.5 mm, or greater than or equal to about 3.0 mm. In some embodiments, the width of the pre-impregnated tape is less than or equal to about 20.0 mm, less than or equal to about 15.0 mm, less than or equal to about 10.0 mm, less than or equal to about 8.0, less than or equal to about 6.0 mm, less than or equal to about 5.0 mm, or less. Combinations of the above ranges are possible, for example, in some embodiments, the width of the tape is greater than or equal to about 1 mm and less than or equal to about 20.0 mm. The tape may be wound on to a spool or cassette prior to being introduced to a tape receiver or routing mechanism. In one embodiment, a first roller is used to receive the tape.

In one embodiment, the systems and methods of the disclosure can be used with various fiber reinforced tows. A given tow includes M continuous fibers that are arranged within a carrier or matrix of the tow. The fibers in the tow can include any of the fibers disclosed herein and can have various cross-sectional geometries. Typically, each fiber in a tow has a substantially cylindrical cross-section and ranges from about 1 to about 20 micrometers in diameter. The number of fibers in a given tow is typically in the thousands (K). Accordingly, a 9K tow has approximately 9,000 fibers that are adjacent each other, disposed in a carrier/matrix and span the length of the tow or a given section thereof. Notwithstanding the foregoing, tows that include reinforcing fibers in the range of about 100 to about 1000 can be used with various system embodiments.

In one embodiment, the dimensions of a given workpiece, whether composite or composite core with FFF shell, range from about 10 mm to about 300 mm for each of height, width, and length) for a given workpiece. In one embodiment, build region of the systems disclosed herein will range from about 200 mm to about 300 mm in a given X, Y, or Z direction. In one embodiment, the build region will be about 300 mm (X)×about 200 mm (Y)×about 200 mm (Z).

In various embodiments, the printers, devices, systems, assemblies, methods, and other components of the present disclosure may be used with and combined with the printers, devices, systems, assemblies, methods, and other components of U.S. Ser. No. 17/258,549 filed on Jan. 7, 2021 entitled “SYSTEMS AND METHODS RELATING TO 3D PRINTING COMPOSITE STRUCTURES” and U.S. Ser. No. 17/284,099 filed on Apr. 9, 2021 entitled, “SYSTEMS AND METHODS OF PRINTING WITH FIBER-REINFORCED MATERIALS”, the disclosure of each of which are incorporated by reference herein in their entirety.

The terms “about” and “substantially identical” as used herein, refer to variations in a numerical quantity that can occur, for example, through measuring or handling procedures in the real world; through inadvertent error in these procedures; through differences/faults in the manufacture of materials, such as composite tape, through imperfections; as well as variations that would be recognized by one in the skill in the art as being equivalent so long as such variations do not encompass known values practiced by the prior art. Typically, the term “about” means greater or lesser than the value or range of values stated by 1/10 of the stated value, e.g., ±10%.

For instance, applying a length of composite tape of about 12 inches to an element can mean that the composite tape is a length between 10.8 inches and 13.2 inches. Likewise, wherein values are said to be “substantially identical,” the values may differ by up to 5%. For instance, a strip of composite tape is a long rectilinear shape, both before and after the application of heat, even though applying heat can affect the shape of the composite tape. Whether or not modified by the term “about” or “substantially” identical, quantitative values recited in the claims include equivalents to the recited values, e.g., variations in the numerical quantity of such values that can occur, but would be recognized to be equivalents by a person skilled in the art. In various embodiments, tape segments maintain a substantially identical rectangular shape before and after processing in various embodiments subject to some minor variations as described herein.

The use of headings and sections in the application is not meant to limit the disclosure; each section can apply to any aspect, embodiment, or feature of the disclosure. Only those claims which use the words “means for” are intended to be interpreted under 35 USC 112, sixth paragraph. Absent a recital of “means for” in the claims, such claims should not be construed under 35 USC 112. Limitations from the specification are not intended to be read into any claims, unless such limitations are expressly included in the claims.

When values or ranges of values are given, each value and the end points of a given range and the values there between may be increased or decreased by 20%, while still staying within the teachings of the disclosure, unless some different range is specifically mentioned.

Throughout the application, where compositions are described as having, including, or that includes specific components, or where processes are described as having, including or that includes specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise. Moreover, the singular forms “a,” “an,” and “the” include plural forms unless the context clearly dictates otherwise. In addition, where the use of the term “about” is before a quantitative value, the present teachings also include the specific quantitative value itself, unless specifically stated otherwise.

It should be understood that the order of steps or order for performing certain actions is immaterial so long as the present teachings remain operable. Moreover, two or more steps or actions may be conducted simultaneously.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

It is to be understood that the figures and descriptions of the disclosure have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the disclosure, a single component may be replaced by multiple components, and multiple components may be replaced by a single component, to provide an element or structure or to perform a given function or functions. Except where such substitution would not be operative to practice certain embodiments of the disclosure, such substitution is considered within the scope of the disclosure.

The examples presented herein are intended to illustrate potential and specific implementations of the disclosure. It can be appreciated that the examples are intended primarily for purposes of illustration of the disclosure for those skilled in the art. There may be variations to these diagrams or the operations described herein without departing from the spirit of the disclosure. For instance, in certain cases, method steps or operations may be performed or executed in differing order, or operations may be added, deleted or modified.

What is claimed is:

1. An applicator management system for fabricating 3D parts comprising:
a first applicator;
a housing;
a mount, wherein the mount is moveable in one or more directions within the housing;
a build plate disposed within the housing, wherein position of build plate is adjustable in one or more directions; and
an applicator changer coupled to the moveable mount; wherein the applicator changer includes a first interface to operatively engage the first applicator and a second applicator.

2. The system of claim 1, wherein the first interface is selected from the group consisting of a magnetic coupler, a ball lock, a tongue and groove system, an interference fit coupler, and an electric coupler.

3. The system of claim 1, wherein the second applicator is selected from the group consisting of an inspection applicator, a metrology applicator, a cutting applicator, a combination applicator that includes functions of two or more applicators, and a drill applicator.

4. The system of claim 1, the build plate translates along the z-axis defined by the inner perimeter of the housing.

5. The system of claim 1, wherein the first interface is a magnetic coupler comprising a slider assembly comprising one or more magnetics and a fixed assembly comprising one or more magnetics, wherein the slider assembly is magnetically repelled from the fixed assembly.

6. The system of claim 1, wherein the first interface comprises a magnetic dock assembly.

7. The system of claim 6, wherein the magnetic dock assembly comprises a slider assembly defining a first hole and a second hole, the slider assembly comprising a first magnet and a second magnet.

8. The system of claim 7, further comprising a docking pin assembly comprising a first pin and a second pin, and a third magnet and fourth magnet, wherein poles of first magnet and third magnet are oriented to repel each other, wherein the first pin is positioned to enter the first hole and wherein the second pin is positioned to enter the second hole.

9. The system of claim 8, wherein the slider assembly is slidably disposed relative to the first pin and the second pin.

10. The system of claim 6 wherein the magnetic dock assembly comprises
a fixed assembly comprising a pair of elongate pins, a first pair of magnets, and an upper portion and a lower portion; and
a slider assembly comprising a second pair of magnets and a first stop and a second stop, wherein the slider assembly defines a pair of holes, wherein the pair of holes are sized to receive the pair of elongated pins, wherein the first stop grips the upper portion, wherein the second stop grips the lower portion.

11. The system of claim 10 further comprising a contact sensor and a printer, the printer comprising a control system, wherein the control system directs printing using one or more tools and applicators and grabbing and docking the one or more tools in the magnetic dock assembly.

12. The system of claim 11, wherein the contact sensor generates a signal or stops transmitting a signal to the control system indicative of whether a tool is docked in the magnetic dock assembly.

13. The system of claim 1, wherein the control system is programmed to perform a reset or homing operation in response to receiving a signal indicative of a change in tool docking status.

14. The system of claim 1, wherein the first applicator is a fiber-reinforced polymer prepreg tape based applicator.

15. The system of claim 1, further comprising the second applicator.

16. The system of claim 1, wherein the second applicator is a fused filament fabrication-based applicator.

17. The system of claim 1, wherein the second applicator is a metal-based printing applicator.

18. The system of claim 1, further comprising a tool grabber and a control system.

19. The system of claim 18, further comprising a contact sensor in electrical communication with the control system and positioned to selectively contact the magnetic dock assembly when the magnetic dock assembly is in one or more sensor contacting positions.
